(19) United States
(12) Patent Application Publication
(10) Pub. No.: US 2006/0286311 A1
(43) Pub. Date: Dec. 21, 2006

(54) Composition for nonlinear optical material, optical element, nonlinear optical material, and process for producing the same

(75) Inventors: Masaki Okazaki, Minami-ashigara-shi (JP); Naoyuki Nishikawa, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-ashigara-shi (JP)

(21) Appl. No.: 11/448,841

(22) Filed: Jun. 8, 2006

(30) Foreign Application Priority Data
Jun. 8, 2005 (JP) 2005-168220

(51) Int. Cl. C09K 19/38; C09K 19/52; C09K 19/54; G02F 1/361; F21V 9/00

(52) U.S. Cl. 428/1.1; 252/299.01; 252/299.5; 252/582

(57) ABSTRACT

A novel nonlinear optical material is disclosed. The nonlinear optical material comprises a nonlinear optically-responsive layer formed by exposing a layer of a composition to light under an external electric field or an external magnetic field. The composition comprises a liquid crystalline/nonlinear optically-responsive compound having a polymerizable group and a nonlinear optically-responsive group, and a compound having at least one photoresponsive isomerization group, or comprises a polymer having a nonlinear optically-responsive group and a photoresponsive isomerization group.

This application claims benefit of priority under 35 U.S.C. 119 to Japanese Patent Application No. 2005-168220 filed Jun. 8, 2005.

### BACKGROUND OF THE INVENTION

1. Field of the Invention

The present invention relates to novel nonlinear optical materials useful in optoelectronics and photonics fields, a composition useful for the production of the same, an optical element, and process for producing a nonlinear optical material.

2. Related Art

With development of advanced information society, there have been many attempts of employing optical technologies in information transmission, information processing and information memorizing. Under such a circumstance, materials exhibiting a nonlinear optical effect (nonlinear optical materials) has been noted in optoelectronics and photonics fields. The nonlinear optical effect is a phenomenon that when strong electric field (photoelectric filed) is applied to a substance, the substrate generates an electric polarization having a nonlinear relationship with the electric field applied; and the term of “nonlinear optical material” is used for any materials showing such nonlinear properties remarkably. Materials generating a second harmonic or materials showing Pockels effect (primary electro-optical effect) which induces refractive index change in proportion to the first order of electric field are known as nonlinear optical materials utilizing a secondary nonlinear response. In particular, the latter is investigated to apply to electro-optical (EO) light modulation devices or photorefractive devices. Further, the materials are expected to show piezoelectric properties and pyroelectric properties, and are therefore expected to apply to various fields.

Previously, inorganic nonlinear optical materials have been mainly studied and employed in producing devices. However, from the points of 1) exhibiting large nonlinear properties, 2) fast response rate, 3) high optical damage threshold, 4) wide variety of molecular design being possible, 5) excellent production applicability, and the like, organic materials come into receive a lot of notices. However, it is necessary for development of a secondary nonlinear optical effect that electric polarization induced by electric field lacks reverse inversion center. For this reason, producing such materials, it is necessary that molecules showing nonlinear optical effect or nonlinear optically-responsive groups are arranged in a structure having no inversion symmetry center (see Nonlinear Optical Properties of Organic and Polymeric Material, ACS SYMPOSIUM SERIES 233, David J. Williams (American Chemical Society, 1983); Organic Nonlinear Optical Material, supervised by Masao Kato and Hachiro Nakanishi (C.M.C. Co., 1985); Nonlinear Optical Properties of Organic Molecules and Crystals, vol. 1 and 2, D. S. Chemla and J. Zyss (Academic Press Co., 1987); and Molecular Nonlinear Optics, J. Zyss (Academic Press Co., 1994)).

The conventional technologies, for arranging molecules showing nonlinear optical effect or nonlinear optically-responsive groups in a structure having no inversion symmetry center, of introducing molecules showing nonlinear optical effect or nonlinear optically-responsive groups into an organic polymer, and orienting their dipoles, if necessary under electric field, have been widely utilized. This orientation control by the electric field is called “poling”, and an organic polymer poled is called “electric field oriented polymer” (poled polymer). Specifically, it is a procedure that dipoles of molecules showing secondary nonlinear optical effect or response groups are oriented by applying high voltage at a temperature higher than the glass transition temperature of a base polymer, and then cooled to freeze orientation of the dipoles due to electric field. For example, SPIE, vol. 1213, p7 (1990) describes the example of an electro-optical (EO) light modulation device produced by this procedure.

However, in general, efficiency of orientation by poling decreases with increasing the introduction amount of the molecules showing nonlinear optical effect or nonlinear optically-responsive groups in the organic polymer. As a result, large nonlinear optical responsiveness is not yet obtained, and further improvement was demanded (see SCIENCE, vol. 288, page 117 (2000)).

In addition, those materials suffer from low stability such that orientational relaxation thermally occurs with the passage of time, and electro-optic characteristics deteriorate. Thus, this does not enable those materials to put into practical use or apply to a wide range, and the resolution of such a problem was desired (see Mol. Cryst. Liq. Cryst., vol. 189, p3 (1990)).

As a method for suppressing orientational relaxation, for example, a method is proposed, comprising conducting crosslinking of bifunctional non-liquid crystallinity molecules such as compounds having an epoxy group and an amino group while poling, and chemically freezing orientation. However, this method suffers from causing locally non-uniform structure.

Further, for example, an example of synthesizing a polymerizable long-chain alkylamino derivative of 2-amino-5-nitropyridine as an amphiphilic compound showing a nonlinear optical effect, forming a LB film of the derivative, and then fixing orientation by polymerization is reported (see Thin Solid Film, vol. 210, p195 (1992)). However, the method employing LB method for producing devices employing LB method suffered from generating defects such as pinhole, lacking industrial production applicability, and the like. Further, an example using liquid crystal molecules having nonlinear, optically active groups on the side chain is reported, and, however, any of the examples are not yet reached to ensure a sufficient long-term stability, and further improvement has been desired (see Handbook of Liquid Crystals, vol. 3, Chapter IV, item 4 (1998)).

A method of using a liquid crystalline nonlinear, optically functional compound having plural polymerizable groups is proposed as a method of ensuring the long-term stability (see JP-A-11-322690). However, in this method, stability is secured, but orientation by poling is not always sufficient. Thus, it is not yet reached to obtain large nonlinear optical responsiveness, and further improvement has been demanded.

### SUMMARY OF THE INVENTION

Accordingly, an object of the present invention is to provide a nonlinear optical organic material having a large nonlinear optical responsiveness, and also having no orientational relaxation or suppressed orientation relaxation. Another object of the present invention is to provide a composition, an optical element and production methods useful for the production of the nonlinear optical material.

In one aspect, the present invention provides a composition for a nonlinear optical material, comprising:

at least one liquid crystalline/nonlinear optically-responsive compound having at least one polymerizable group and at least one nonlinear optically-responsive group, and

at least one compound having at least one photoresponsive isomerization group.

The composition may further comprise at least one liquid-crystalline compound having at least one polymerizable group.

The liquid crystalline/nonlinear optically-responsive compound or the liquid-crystalline compound may have a plurality of polymerizable groups.

The compound having at least one photoresponsive isomerization group may be selected from azo compounds.

In other aspect, the present invention provides an optical element comprising a layer formed of the composition of the present invention.

In another aspect, the present invention provides a nonlinear optical material comprising a nonlinear optically-responsive layer formed by exposing a layer formed of the composition of the present invention to light under an external electric field or an external magnetic field.

The light which is employed for exposing the layer may have a peak wavelength of from 200 to 700 nm.

The nonlinear optically-responsive layer may comprise a polymer of the liquid crystalline/nonlinear optically-responsive compound.

The composition may comprise at least one liquid-crystalline compound, and in such an embodiment, the nonlinear optically-responsive layer may comprise a polymer of the liquid-crystalline compound.

In another aspect, the present invention provides an optical element comprising a layer comprising at least one polymer having at least one nonlinear optically-responsive group and at least one photoresponsive isomerization group, and an optical element comprising an optical layer comprising at least one polymer having at least one nonlinear optically-responsive group and at least one compound having at least one photoresponsive isomerization group.

The layer may further comprise a compound having at least one photoresponsive isomerization group.

In another aspect, the present invention provides a non-linear optical material comprising a nonlinear optically-responsive layer formed by exposing a layer formed of a composition to light under an external electric field or an external magnetic field,

wherein the composition comprises at least one polymer having at least one nonlinear optically-responsive group and at least one photoresponsive isomerization group, or comprises at least one polymer having at least one nonlinear optically-responsive group and at least one compound having at least one photoresponsive isomerization group.

In another aspect, the present invention provides a process for producing a nonlinear optical material comprising exposing a composition of the present invention to light under an external electric field or an external magnetic field, thereby forming a nonlinear optically-responsive moiety; and a process for producing a nonlinear optical material comprising exposing a polymer, having at least one nonlinear optically-responsive group and/or at least one photoresponsive isomerization group, to light under an external electric field or an external magnetic field, thereby forming a nonlinear optically-responsive moiety.

The nonlinear optical material of the present invention may be used as an electro-optical (EO) light modulation material.

According to the present invention, for example, molecules having a polymerizable group and a nonlinear optical nonlinear optically-responsive group are aligned in the presence of molecules having a photoresponsive isomerization group, and the alignment of the molecules is carried out at the same time as inducing steric isomerization or structural isomerization, thereby to developing a high polarization orientation state. And the polarization orientation state can be fixed by polymerization of the polymerizable group. As a result, a nonlinear optical organic material having a large nonlinear optical responsiveness, and also having no orientational relaxation or suppressed orientation relaxation can be provided.

### DETAILED DESCRIPTION OF THE INVENTION

The present invention is described in detail below. It is to be understood, in this patent specification, that the term “ . . . to . . . ” is used as meaning a range inclusive of the lower and upper values disposed therebefore and thereafter.

One embodiment of the present invention relates to an optical element comprising a layer formed of a composition. The composition comprises a liquid crystalline/nonlinear optically-responsive compound having at least one polymerizable group and at least one nonlinear optically-responsive group, and a compound having at least one photoresponsive isomerization group. When the layer is irradiated with light while being applied with an external electric field or external magnetic field, photoisomerization of the compound having photoresponsive isomerization groups proceeds, and simultaneously molecules of the liquid crystalline/nonlinear optically-responsive compound are polarization oriented. After that, polymerization of liquid crystal molecules is allowed to proceed while maintaining its orientation state. As a result, a nonlinear optically-responsive layer developed by the polarizing orientation is formed.

I. Liquid Crystalline/Nonlinear Optically-Responsive Compound Having at Least One Polymerizable Group and at Least One Nonlinear Optically-Responsive Group

The term “liquid crystalline/nonlinear optically-responsive compound having at least one polymerizable group and at least one nonlinear optically-responsive groups” (hereinafter referred to as “liquid crystalline/nonlinear optically responsive compound” for brevity) are used herein for any compounds which can be a nonlinear optically-responsive compound having a polymerizable group(s) when not revealing liquid crystallinity, and can be a liquid crystalline compound having a polymerizable group(s) when not revealing nonlinear optical responsiveness, and is also used herein for any compounds exhibiting both of nonlinear optically-responsiveness and liquid-crystallinity and having a polymerizable group(s).

The term “polymerizable group” is used herein for any functional groups employed in any polymerization processes as described in, for example, Shunsuke Murahashi, Polymer Chemistry, Chapters 2-5, Kyoritsu Shuppan Co., Ltd. (1966), and examples thereof include unsaturated bonds (constituent atom may be either of carbon atom and non-carbon atom), small-membered heterocycles such as oxirane or aziridine, and heterogenous functional group combinations such as a combination of an isocyanate and an amine added thereto. The preferable examples of the polymerizable group include double bonds such as an acryloyloxy group, a methacryloyloxy group and a vinyloxy group, as described in research reports by R. A. M. Hikmet, et al. (Macromolecules, Vol. 25, p4194 (1992) and Polymer, Vo. 34, 8, p1763 (1993)) and research report by D. J. Broer et al. (Macromolecules, Vol. 26, p1244 (1993)). Of those, an acryloyloxy group is particularly preferable.

The term “nonlinear optically-responsive group”, as described in the above-described literature references, mainly means a functional group having both of at least one electron-donating group and at least one electron-withdrawing group in one π-conjugated system.

The electron-donating group means a substituent having Hammett's substituent constant σp<0 or σp⁺<0, and the electron-withdrawing group means a substituent having Hammett's substituent constant σp>0 or σp⁺>0. Whether using either of σp or σp⁺ depends on properties of π-conjugated system present between the electron-donating group and the electron-withdrawing group. The Hammett's substituent constant is described in detail in Corwin Hansch, A. Leo and R. W. Taft, Chemical Review, Vol. 91, pp165-195 (1991).

Representative example of the nonlinear optically-responsive group include residues of 4-nitroaniline derivative, 4-amino-4′-nitroazobenzene derivative, 4-amino-4′-nitrostilbene derivative, 4-alkoxy-4′-nitrostilbene derivative, 4-amino-4′-cyanoazostilbene derivative, and 4-amino-4′-nitrotolane derivative.

The term “liquid crystalline compound” used herein can refer to, for example, Flussige Kristalle in Tabellen II (VEB Deutsche Verlag fur Grundstoff Industrie, Leipzig, 1984), particularly, the description of pages 7 to 16, and Handbook of Liquid Crystals, Editing Committee of Handbook of Liquid Crystals, (2000), Maruzen Co., Ltd., particularly the description of Chapter 3. The liquid crystalline compound is preferably a thermotropic liquid crystal, and more preferably a rod-shaped liquid crystal and a discotic liquid crystal. Among those, the rod-shaped liquid crystals showing a nematic phase or a smectic A phase are more preferable, and the discotic liquid crystal showing a discotic nematic phase is more preferable. As the examples of the main skeleton of the mesogen group or the liquid crystal molecule contributing to the formation of a stiff liquid crystal called a core in the rod-shaped liquid crystal, ones described in the above literature references can be used.

Of those, the preferable examples include biphenyl derivatives, phenylene carbonyloxybiphenyl derivatives, carbonyloxybiphenyl derivatives, terphenyl derivatives, naphthylene carbonyloxyphenyl derivatives, phenylene ethenylene carbonyloxybiphenyl derivatives, phenylene ethynylene phenyl derivatives, phenyl benzoate derivatives, benzilydene aniline derivatives, azobenzene derivatives, azoxybenzene derivatives, stilbene derivatives, phenylene ethynylene carbonyloxybiphenyl derivatives, naphthylene biphenyl derivatives, and those derivatives in which benzene rings are saturated or are substituted with heterocycles. The preferable examples of the core of the discotic liquid crystal include benzene derivatives, triphenylene derivatives, toluxene derivatives, phthalocyanine derivatives, porphyrin derivatives, anthracene derivatives, and β-diketone metal complex derivatives.

Examples of the liquid crystalline/nonlinear optically-responsive compound include the compounds represented by the following formula (1).

Formula (1)

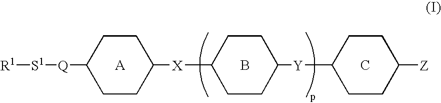

In the formula, R¹ represents a polymerizable group, and examples thereof include an acryloyl group, a methacryloyl group and an oxyranyl group. S¹ represents a divalent linking group, and examples thereof include an oxygen atom, a sulfur atom, an amino group which may be substituted, a carbonyl group, an alkylene group, and combinations thereof. Q represents a divalent linking group, and is preferably a divalent linking group selected from the group consisting of an oxygen atom, a sulfur atom, an amino group which may be substituted, and a carbonyloxy group. Rings A, B and C represent an aromatic hydrocarbon ring, an aliphatic hydrocarbon ring, or a heterocycle, which may be substituted, and examples thereof include a benzene ring, a cyclohexane ring, a piperidine ring, a pyridine ring, pyrimidine ring, a dioxane ring, a furan ring, a thiophene ring and a naphthalene ring. Those rings may have substituents on the respective ring, and if possible, the substituents on the ring may bond with each other to form a ring. X and Y each independently represent a single bond, —CH₂CH₂—, —CH═CH—, —C≡C—, —C≡C—C≡C—, —COO—, —OCO—, —O—, —CH₂O—, —OCH₂—, —N═N—, —CH═N—, —C═C—CO— or —CO—C═C—. The group formed by ring A, X, ring B, Y and ring C corresponds to a liquid crystallinity-developing core. Z represents, for example, a nitro group, a cyano group, a halogen atom, a trihalogenomethyl group, an alkyl group, an alkoxy group, an amino group, a monoalkylamino group, a dialkylamino group (the alkyl groups included therein may bond with each other to form a ring), a carboxyoxyalkyl group, and a sulfonyloxyalkyl group. In the formula, one of the group Z and the group R¹—S¹-Q shows an electron-donating property and another shows an electron-withdrawing property. p is an integer of from 0 to 2.

Examples of the above-described substituent include an alkyl group having from 1 to 12 carbon atoms, an alkenyl group having from 2 to 12 carbon atoms, an alkynyl group having from 2 to 12 carbon atoms, an aryl group having from 6 to 12 carbon atoms, a heterocyclic group, a cyano group, a carboxyl group, a carbamoyl group, an alkoxycarbonyl group having from 1 to 12 carbon atoms, an aryloxycarbonyl group having from 6 to 12 carbon atoms, an acyl group having from 1 to 12 carbon atoms, a halogen atom, an amino group, an alkylamino group having from 1 to 12 carbon atoms, an arylamino group having from 6 to 12 carbon atoms, an acylamino group having from 1 to 12 carbon atoms, an alkylsulfonylamino group having from 1 to 12 carbon atoms, an arylsulfonylamino group having from 6 to 12 carbon atoms, an ureido group, an alkoxy group having from 1 to 12 carbon atoms, an aryloxy group having from 6 to 12 carbon atoms, an acyloxy group having from 1 to 12 carbon atoms, an alkylsulfonyloxy group having from 1 to 12 carbon atoms, an arylsulfonyloxy group having from 6 to 12 carbon atoms, an alkylthio group having from 1 to 12 carbon atoms, an arylthio group having from 6 to 12 carbon atoms, an alkylsulfonyl group having from 1 to 12 carbon atoms, an arylsulfonyl group having from 6 to 12 carbon atoms, a sulfo group, and a sulfamoyl group. It is preferred that either of S¹, ring A, ring B, or ring C has a substituent containing a polymerizable group.

When the compound of the formula (1) does not develop liquid crystallinity, the compound becomes a nonlinear optically responsive compound having a polymerizable group, and when the compound does not develop nonlinear optical responsiveness, the compound becomes a liquid crystalline compound having a polymerizable group. Of course, the compound may be a compound developing both properties.

Examples of the liquid crystalline/nonlinear optically-responsive compound include, but are not to be limited to, those shown below. 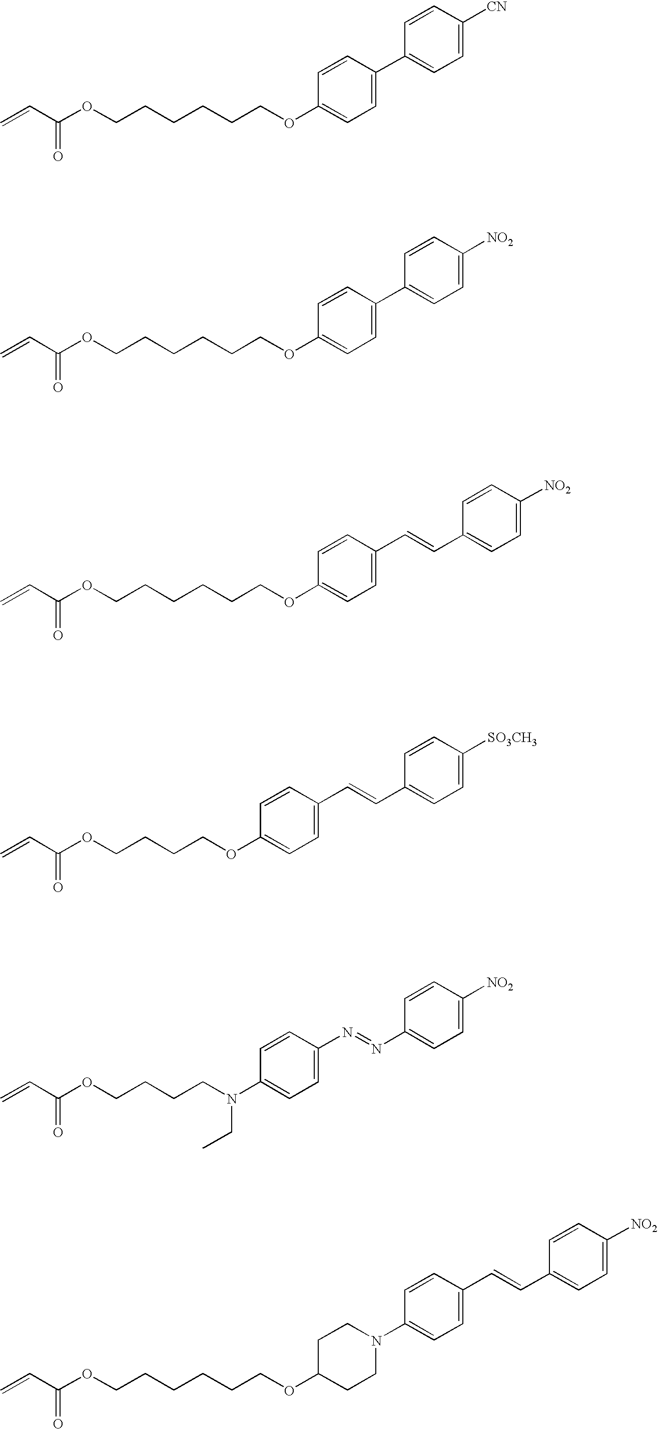 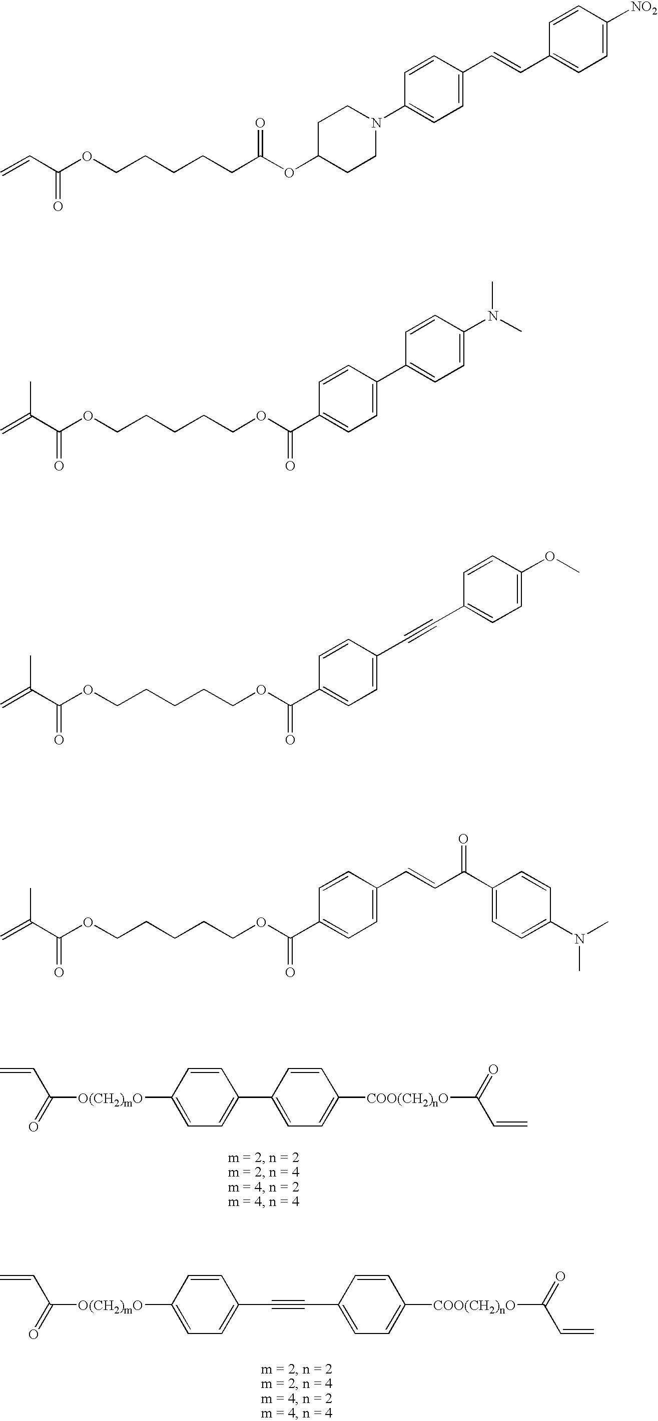 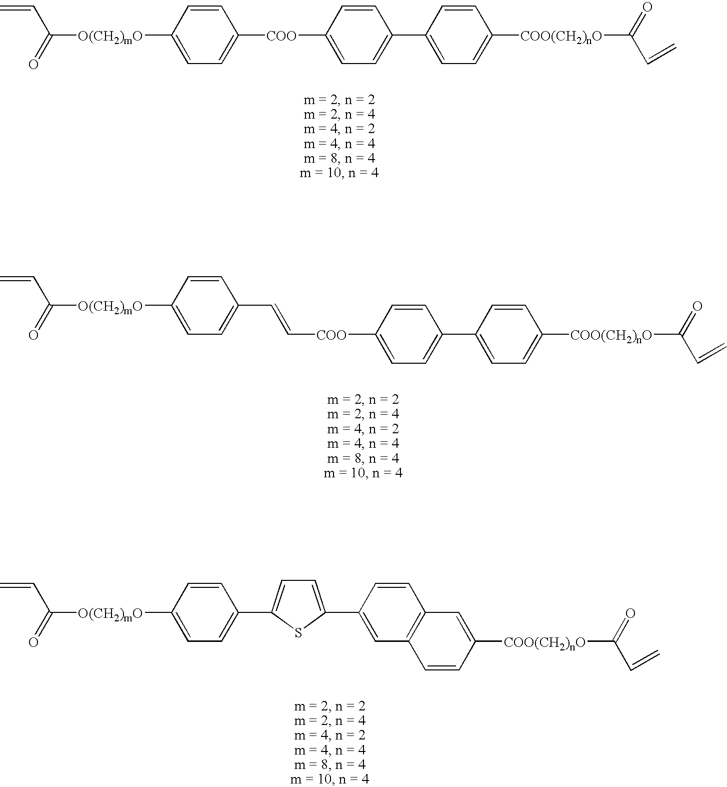
II. Compound Having Photoresponsive Isomerization Group

The term “photoresponsive isomerization group” used herein means a group causing steric isomerization or structural isomerization by light within a wavelength range, and preferably further causing its reverse isomerization by light without the above wavelength range or by heat. Those compounds having such a group are generally known as a photochromic compound which involves structural change and also color tone change in a visible light region. Examples of the compound include azobenzene compounds, benzaldoxime compounds, azomethine compounds, stilbene compounds, spiropyrane compounds, spirooxazine compounds, fulgide compounds, diarylethene compounds, cinnamic acid compounds, retinal compounds, and hemithioindigo compounds. Of those, compounds having at least one azo group are preferable.

The photoresponsive isomerization compound, which can be used in this embodiment, that is, the compound having a functional group capable of photoisomerizing, may be a low molecular weight compound or a polymer. In the case of the polymer, the polymer can exhibit the same function even though the photoresponsive isomerization group is present in the main chain or the side chain. Further, the polymer may be a homopolymer or a copolymer. Copolymerization ratio of the copolymer is appropriately be used in the value which should suitably adjust polymer properties such as isomerizability and Tg. Examples of the main chain of the polymer include a polystyrene, a malonic polyester, a polyacrylate, a polymethacrylate, a polysiloxane, a polyacrylamide, a polymethacrylamine, a polyoxyalkylene, a terephthalic polyester, a polyallylamine, a polydicarbonic amide, a polyurethane, a polyoxyphenylene, a polyvinyl alcohol, and a polyco(vinylidene chloride) (methacrylate).

The compound having a functional group capable of photoisomerizing may simultaneously be the liquid crystalline/nonlinear optically-responsive compound. In other words, the molecule of the liquid crystal compound may contain the functional group capable of photoisomerizing. Those are specifically described in, for example, Polymer, 41, (12), p884 (1992); Chromic material and Application, p221, CMC Publishing Co.; Mechanochemistry, p21, Maruzen Co.; Polymer Collected Papers, vol. 147, Number 10, p771 (1991); and the like.

In this embodiment, the composition may further contain a liquid crystalline compound having a polymerizable group, other than the liquid crystalline/nonlinear optically-responsive compound. The definition and preferable exmaples of the “polymerizable group” and “liquid crystalline compound” are the same as described before. Where the liquid crystalline/nonlinear optically-responsive compound and/or the liquid crystalline compound having a polymerizable group have plural polymerizable groups, orientational relaxation can further be suppressed, which is preferable.

In this embodiment, the content of the liquid crystalline/nonlinear optically-responsive compound in the composition is preferably from 30 to 99.7 wt %, and more preferably from 50 to 95 wt %. The content of the compound having a photoresponsive isomerization group in the composition is preferably from 0.3 to 25 wt %, and more preferably from 3 to 15 wt %. In the embodiment further employing at least one liquid crystalline compound having at least one polymerizable group, the content of such a liquid crystalline compound is preferably from 0 to 50 wt %, and more preferably from 0 to 30 wt %.

Another embodiment of the present invention relates to an optical element comprising a layer comprising a polymer having at least one nonlinear optically-responsive group and at least one photoresponsive isomerization group, or comprising a polymer having at least one nonlinear optically-responsive group and a compound having at least one photoresponsive isomerization group. When the layer is irradiated with light while being applied with an external electric field or external magnetic field, photoisomerization of the polymer or compound having photoresponsive isomerization groups proceeds, and simultaneously molecules of the polymer having the nonlinear optically-responsive group are polarization oriented. After that, polymerization of molecules is allowed to proceed while maintaining its orientation state. As a result, a nonlinear optically-responsive layer developed by the polarizing orientation of the nonlinear optically-responsive group is formed.

III. Polymer Having at Least One Nonlinear Optically-Responsive Group

The term “polymer having at least one linear optically-responsive group” employed in this embodiment is used for any polymers having the linear optically-responsive group in the main chain and/or in the side chain. It is preferable that the linear optically-responsive group is present in the side chain. The polymer may be a homopolymer or a copolymer. Copolymerization ratio of the copolymer is appropriately used in the value which should suitably adjust polymer properties such as nonlinear optical responsiveness and Tg. Examples of the main chain of the polymer include a polystyrene, a malonic polyester, a polyacrylate, a polymethacrylate, a polysiloxane, a polyacrylamide, a polymethacrylamide, a polyoxyalkylne, a terephthalic polyester, a polyallylamide, a polydicarbonic amide, a polyurethane, a polyoxyphenylene, a polyvinyl alcohol, and a polyco(vinylidene chloride) (methacrylate).

The polymer having a photoresponsive isomerization group means a polymer containing at least one photoresponsive isomerization group in the main chain or in the side chain. The photoresponsive isomerization group used here is the same as defined in the description of the photoresponsive isomerization group.

The polymer employed in this embodiment has at least a nonlinear optically-responsive group, and may have both the nonlinear optically-responsive group and the photoresponsive isomerization group. Other compound (preferably other low molecular weight compound) having the photoresponsive isomerization group may be contained. One functional group may be provided with both functions of the nonlinear optically-responsive group and the photoresponsive isomerization group. The polymer may have a polymerizable group, and the polymerizable group is the same as defined in the above-described polymerizable group.

The molecular weight of the polymer employed in this embodiment preferably falls, however not to be limited to, within from 10,000 to 200,000, more preferably within 15,000 to 150,000, and much more preferably within 25,000 to 100,000.

Examples of the polymer having at least one nonlinear optically-responsive group and at least one photoresponsive isomerization group include, but are not to be limited to, those shown below. In the following formulae, if there are m and n, m and n respectively represent a mole ratio of each monomer, provided that the sum of m and n is 100 and neither m nor n is 0. The examples are not limited to those shown below, and include the polymers having any combinations of m and n satisfying that the sum of m and n is 100 and neither m nor n is 0. Example Nos. P-1 to P-16 having m and n satisfying the relation of m<n (more preferably n is from 70 to 97) are preferred; and Example Nos. P-17 to P-27 having m and n satisfying the relation of m>n (more preferably m is from 70 to 97) are preferred.

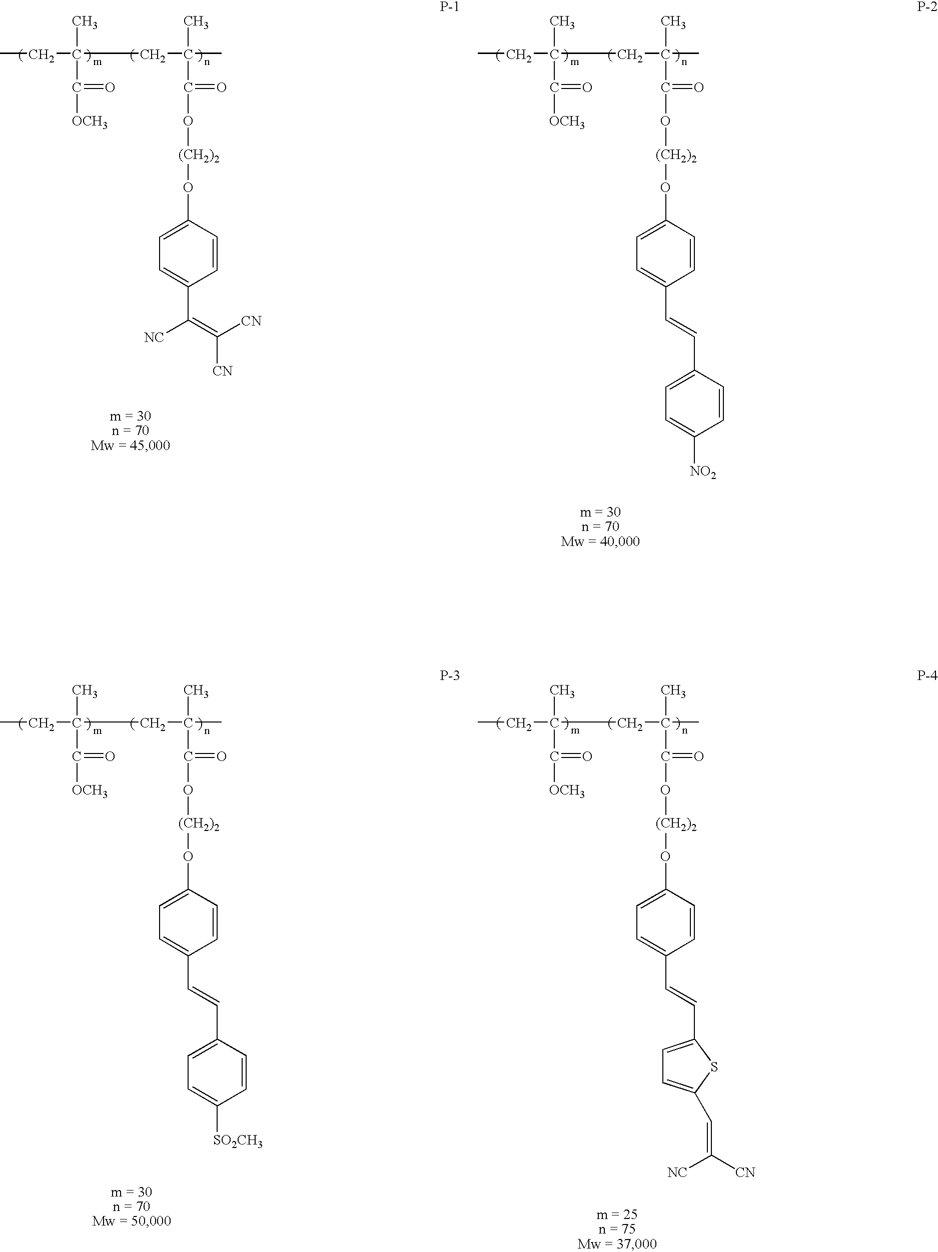

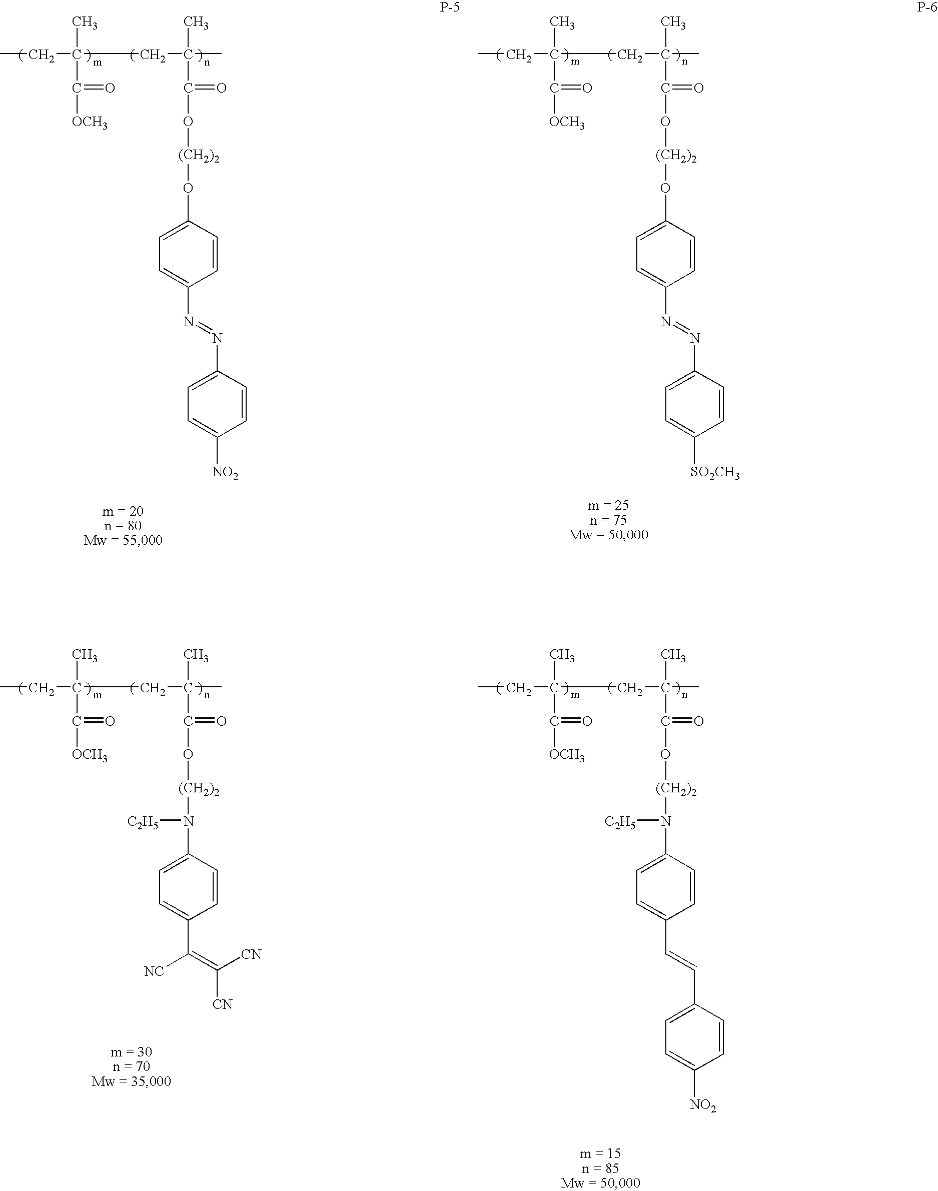

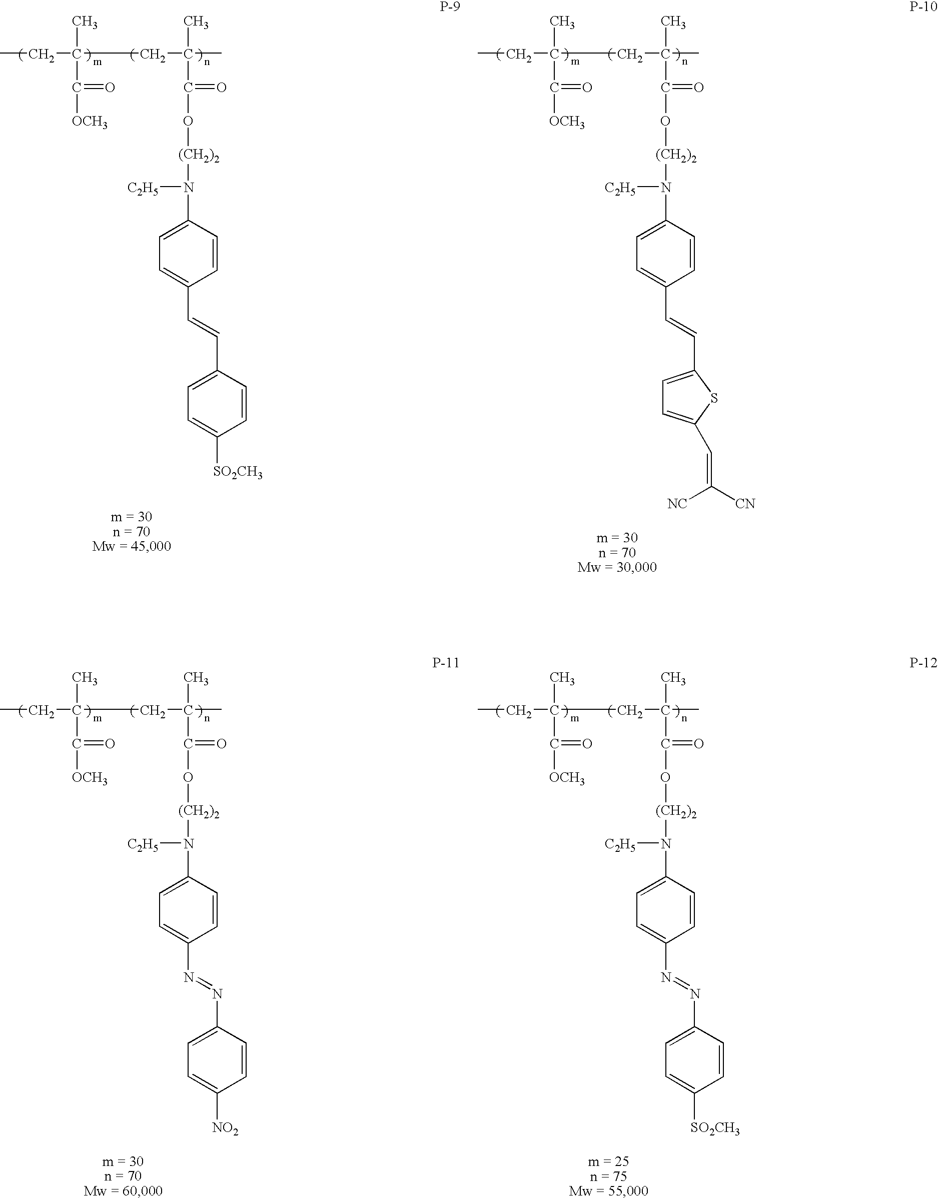

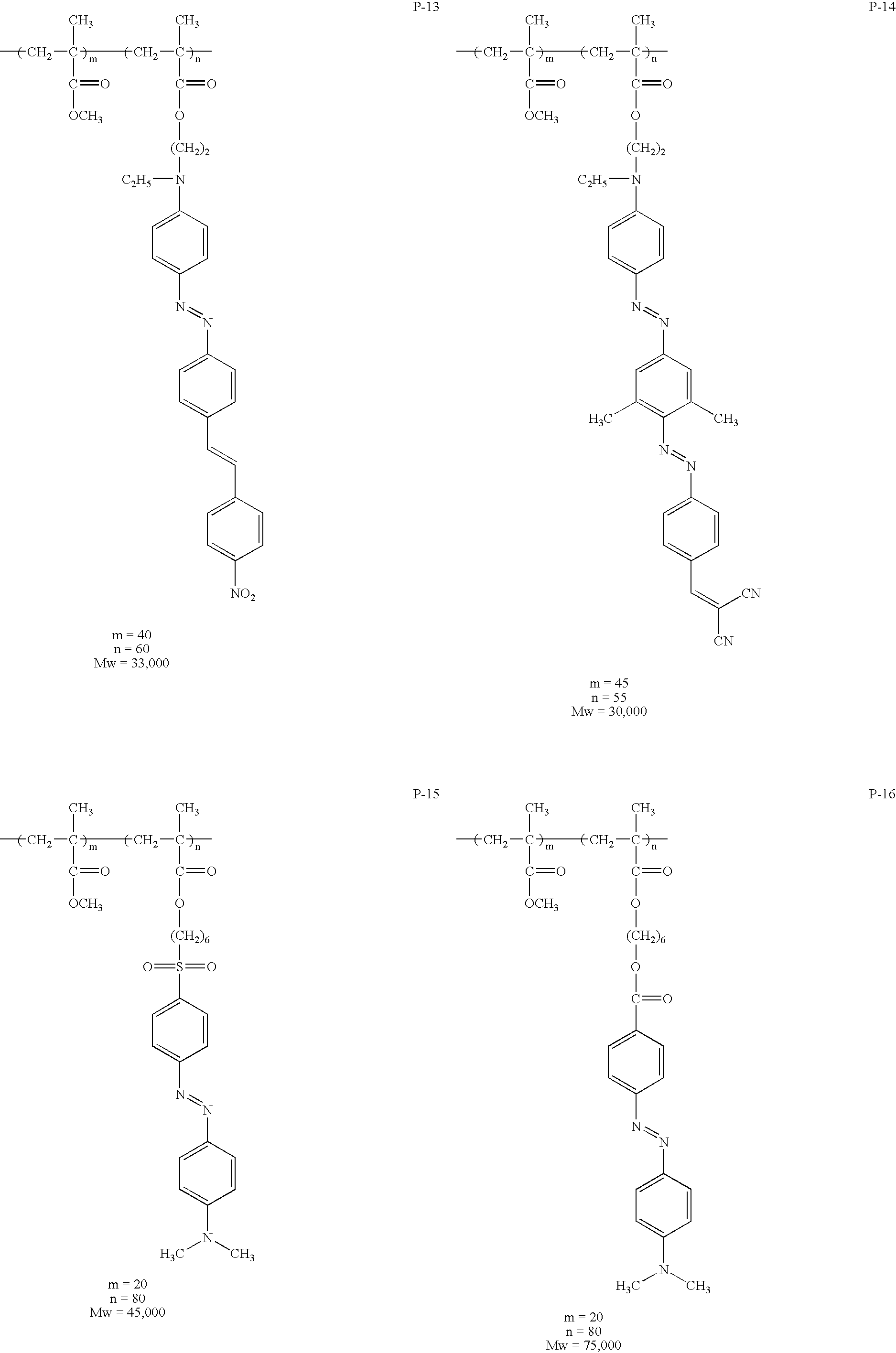

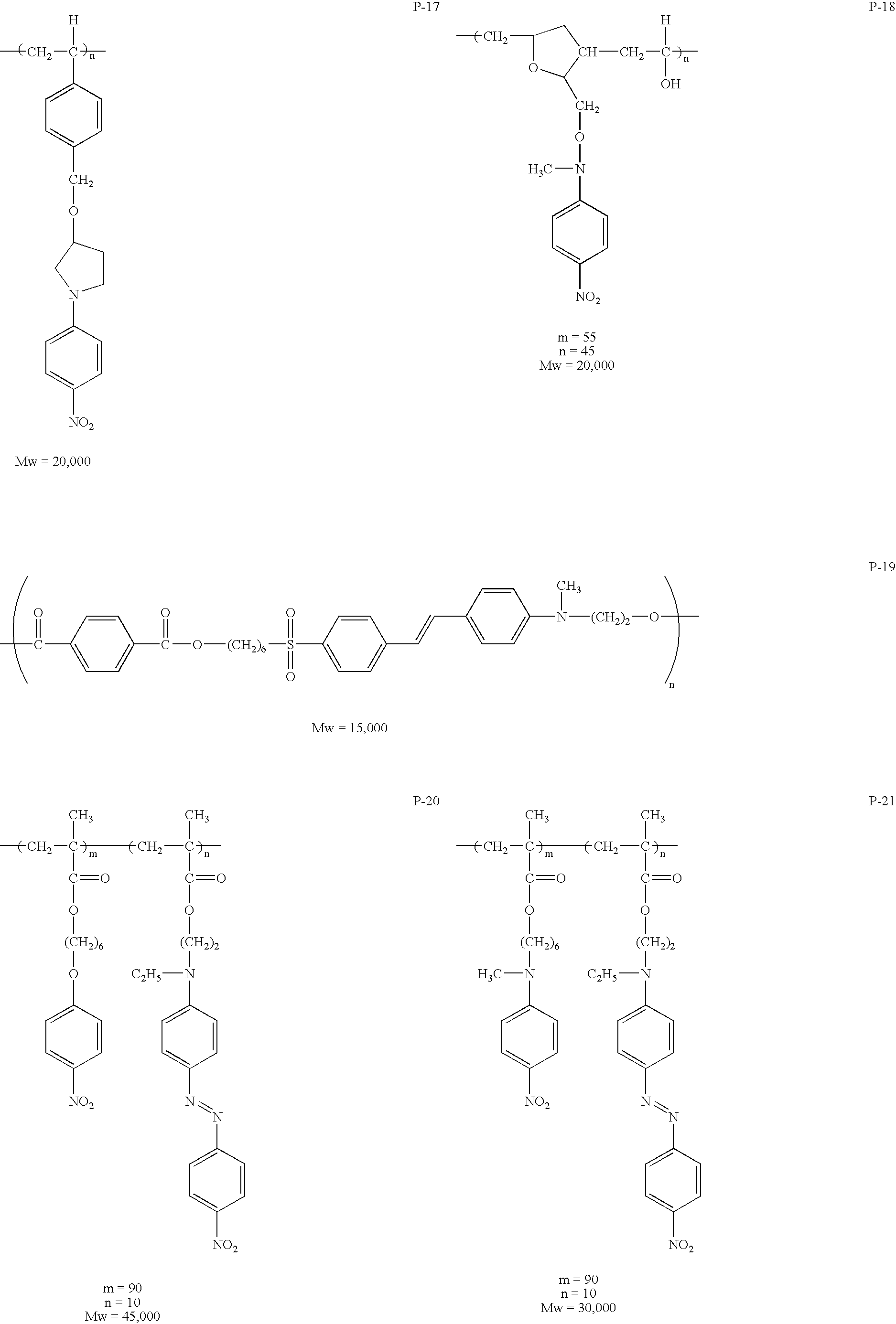

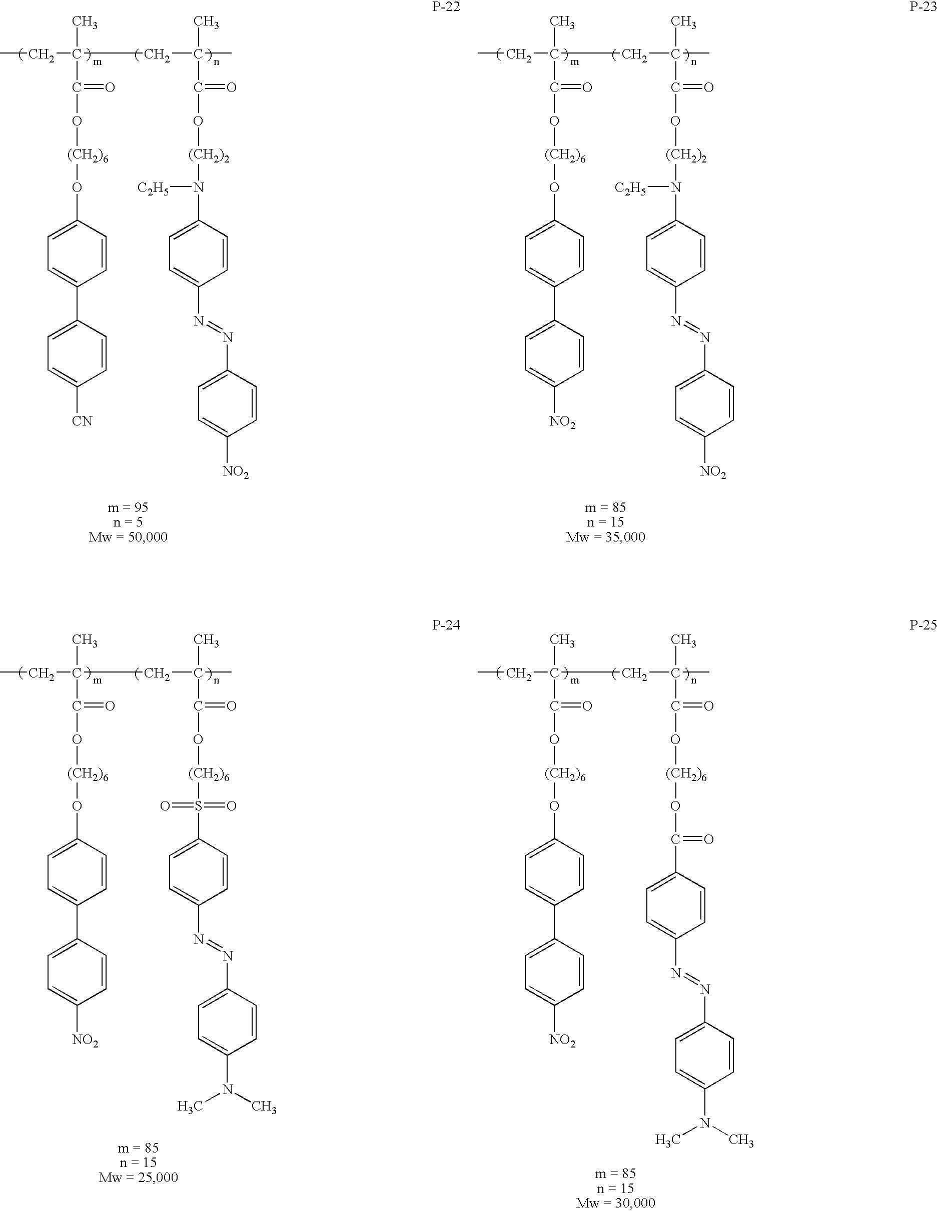

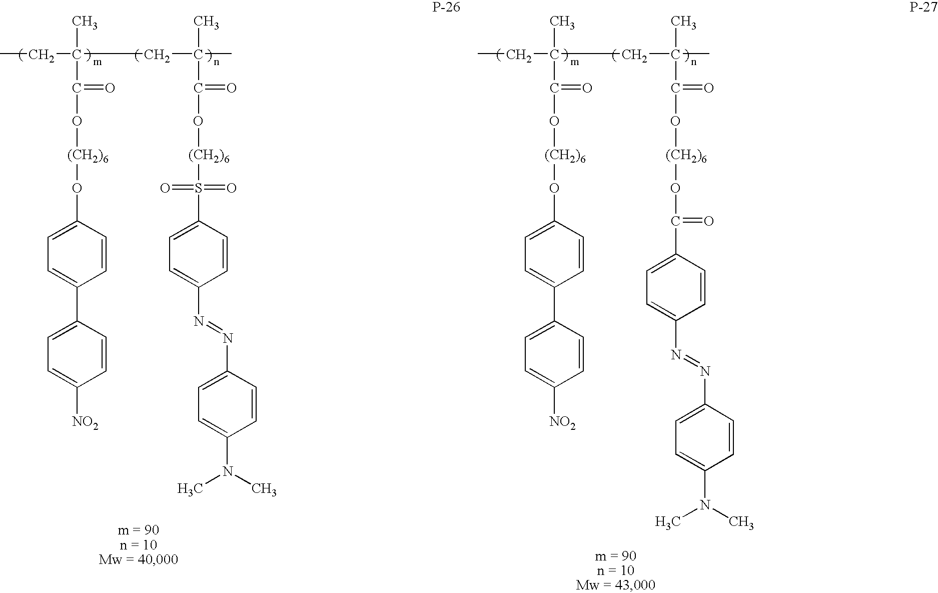

In this embodiment, the layer may further comprise at least one compound having a photoresponsive isomerization group, in addition to the polymer. The detail of the compound having a photoresponsive isomerization group is the same as described above. The preferable examples of such a compound are also the same as described above. The compound is added to the polymer in an amount of preferably from 0.3 to 25 wt %, and more preferably from 3 to 15 wt %.

IV. Nonlinear Optical Material

The present invention also relates to a nonlinear optical material comprising a nonlinear optically-responsive layer. The nonlinear optical material can be produced according to any process. And one example will be explained below.

(1) Formation Step of Nonlinear Optically-Responsive Layer on Substrate or Between Substrates

An optical layer (a) consisting of a composition comprising a liquid crystalline compound having both of at least one polymerizable group and at least one nonlinear optically-responsive group, and a compound having at least one photoresponsive isomerization group; or a layer (b) containing a polymer having both of at least one nonlinear optically-responsive group and at least one photoresponsive isomerization group, or containing a polymer having at least one nonlinear optically-responsive group and a compound having at least one photoresponsive isomerization group, is formed on a substrate or between a pair of substrates. In the embodiment (a), the molecule of the liquid crystalline compound constitutes at least a part of the optical layer, and in the embodiment (b), the polymer constitutes at least a part of the optical layer.

The substrate which can be used in the present invention is not limited, but a substrate showing an excellent flatness is preferable. Examples of the substrate include a metal substrate, a silicon substrate and a transparent substrate. Preferable examples of the metal substrate include substrates of gold, silver, copper, aluminum, and the like. Preferable examples of the transparent substrate include substrates of a glass, plastics (such as a polyethylene terephthalate), and the like. If required and necessary, an electrode may be provided on the substrate. Preferable examples of the electrode include a transparent electrode such as ITO or TCO, and a gold electrode. If required and necessary, the substrate itself can be used as the electrode.

An alignment layer may be provided on the substrate or the electrode. Various general methods can be employed for the formation of the alignment layer. Preferable examples of the aliment layer include those known as an alignment layer for liquid crystal such as polyimide films and polyvinyl alcohol films. If required and necessary, an orientation treatment such as a surfactant treatment and a rubbing treatment may be conducted.

If required and necessary, a spacer, a sealing agent, or the like may be disposed on a substrate, or between a pair of substrates.

If required and necessary, the optical layer may comprise appropriate polymerization initiator, polymerization inhibitor, photosensitizer, crosslinking agent, polymerizable monomer, liquid crystal orientation assistant, and the like. Those additives are not always required to have liquid crystallinity. The amount of the additives added is not particularly limited. However, where the optical layer shows a liquid crystallinity, it is preferable that the amount of the additives used is an amount that does not impair its liquid crystallinity.

The optical layer can be formed on the substrate according to any known method. Examples of the method that can be used include a method of applying the ingredients itself to a surface, and a method of applying a fluid which is prepared by dissolving the ingredients in an appropriate solvent, to a surface, and drying the same. The fluid may be applied to a surface according to any conventional coating method, and examples thereof include a curtain coating method, an extrusion coating method, a roll coating method, a spin coating method, a dip coating method, a bar coating method, a spray coating method, a slide coating method, and a print coating method.

A method of injecting the composition containing the ingredients in a space between a pair of substrates can also be employed. General methods such as a dispenser method and a bell jar method are used as the injection method.

(2) Polarizing Orientation Step

By applying an external electric field or an external magnetic field, while being irradiated with light, to the optical layer containing nonlinear optically-responsive groups and photoresponsive isomerization groups as a part of the ingredients, the nonlinear optically-responsive groups and the liquid crystal molecules are polarization oriented in the embodiment (a), and the nonlinear optically-responsive groups, which are contained as a substituent of the polymer, are polarization oriented in the embodiment (b).

Applying an external electric field is preferred, and in particular, it is preferred that the nonlinear optically-responsive groups and the liquid crystal molecules are oriented by applying with an external field according to a contact poling method such as a plain surface electrode poling method or an electrode sandwich poling method, a corona poling method or the like. Those poling methods are described in, for example, Handbooks of Light/Electron Function Organic Material, Asakura Publishing Co. (1995).

Where the nonlinear optically-responsive layer is formed of a liquid crystal composition (embodiment (a)), the application of an external electric field or an external magnetic field is carried out at a temperature falling within the range at which the liquid crystal composition can exhibit a liquid crystal phase. Further, a method of warming up to an isotropic phase under application of an external electric field or an external magnetic filed and then cooling to a liquid crystal phase is also preferably used.

Where the nonlinear optically-responsive layer comprises the polymer (embodiment (b)), it is preferable to carry out the application of an external electric field or an external magnetic field at a temperature higher than a temperature 20° C. lower than Tg of the polymer. It is more preferable to conduct the application at a temperature higher than a temperature 10° C. lower than Tg of the polymer.

Intensity of the external electric field or the external magnetic field used is the intensity suitable for controlling orientation of the liquid crystal molecules or the like.

In the present invention, light irradiation is conducted at the same time as the application of an external electric field or an external magnetic field in order to efficiently promote polarizing orientation. The “light irradiation” used herein means an operation for causing photoisomerization in the photoresponsive isomerization group. A method of applying light at the same time as the application of an electric field orientation (light assist poling) is described in, for example, Chemical Review, pp1817-1845 (2000), American Chemical Society.

Wavelength of light employed varies depending on the photoresponsive isomerization group used, and is not particularly limited so long as it is wavelength necessary for the isomerization. Peak wavelength of light used for light irradiation is preferably from 200 to 700 nm, more preferably from 300 to 700 nm, and most preferably from 400 to 700 nm.

(3) Orientation Fixing Treatment Step

After liquid crystal molecules or the like in the optical layer are aligned in a polarization orientation state under application of an external electric field or an external magnetic field to the optical layer, the optical layer is subjected to an operation for stably maintaining the thus-obtained state, thereby forming the nonlinear optically responsive moiety such as a nonlinear optically responsive layer. As a result, the desired nonlinear optical material can be obtained. The orientation state may be fixed by carrying out polymerization of the moiety to form crosslinking therein. In this case, photopolymerization is preferably employed.

Wavelength of light used is that peak wavelength of light is preferably from 200 to 700 nm, and more preferably from 300 to 700 nm. However, a region that a co-present photoresponsive isomerization group does not absorb is preferable, and the most preferable peak wavelength is from 200 to 400 nm.

The light source used for light irradiation is light sources generally used, and examples thereof include lamps such as a tungsten lamp, a halogen lamp, a xenon lamp, xenon flash lamp, a mercury lamp, a mercury xenon lamp and a carbon arc lamp; various lasers such as a semiconductor laser, a helium neon laser, an argon ion laser, a helium cadmium laser and YAG laser; a light-emitting diode; and a cathode ray tube. The light irradiation may use non-polarized light or polarized light. Where polarized light is used, linear polarized light is preferably used. Further, by using a filter, a wavelength conversion element or the like, only light having a necessary wavelength may be selectively irradiated.

By the light irradiation, the polarization oriented molecules are maintained in a stable state. Specifically, a state having no reversal symmetry, which enables the secondary nonlinear optical effect developed by polarizing orientation to maintain, is stably held by light irradiation. More specific embodiment is, for example, that a covalent bond, an ionic bond or a hydrogen bond is formed between the polarization oriented molecules, or between the polarization oriented molecules and other molecules. Formation of a covalent bond is preferable, and further, formation of covalent bonds derived from the polymerizable groups is preferable. Various conventional crosslinking methods by heat or electromagnetic wave can be employed for the formation of covalent bonds derived from the polymerizable group. Radical polymerization using a photopolymerization initiator or the like under irradiation of ultraviolet ray is particularly preferable. Where the compound having a nonlinear optically-responsive layer is a polymer, polymer molecules may be fixed in the state having no reversal symmetry by cooling down to a temperature lower than Tg of the polymer to freeze movement of polymer molecules. In this case, it is preferable that polymer molecules are fixed in the state by carrying out the above mentioned steps in combination with by carrying out polymerization of the polymerizable group to form covalent bonds derived from the polymerizable groups.

The light irradiation step is carried out so as to cause photoisomerization in photoresponsive isomerization groups and to further promote orientation of photoresponsive isomerization groups and/or liquid crystal molecules. The light irradiation step may be carried out by irradiated with light from a surface side or a back surface side in a normal direction or in an oblique direction to the surface of the substrate. Wavelength and light source of the light irradiation used are the same as described before.

If required and necessary, a substrate can be provided on the nonlinear optically-responsive moiety, depending on the application of the nonlinear optical material. Examples of the substrate are the same as described before.

If required and necessary, the electrode can be provided on the nonlinear optically-responsive moiety or the substrate, depending on the application of the nonlinear optical material. Preferable method of providing the electrode includes gold vapor deposition and platinum vapor deposition. Further, various general electrodes may be supported on the nonlinear optically-responsive moiety or the substrate. Further, if required and necessary, a substrate can be provided on the nonlinear optically-responsive moiety or the above-formed electrode.

The nonlinear optical material of the present invention can be used in various applications. For example, the nonlinear optical material can be utilized in a wavelength conversion element as a nonlinear optical material; a light switch, a terahertz wave material or a photorefractive material as an electro-optical material; an ultrasonic wave oscillator or an actuator as a piezoelectric element; and the like.

### EXAMPLES

Paragraphs below will more specifically explain the present invention referring to Examples and Comparative Examples, wherein the present invention is by no means limited to these Examples. Evaluation of the lubricant composition in Examples and Comparative Examples was carried out according to the methods below.

### Example No. 1

A horizontal orientation cell (a product of E.H.I. Co.), having a space of 2 μm, comprising a pair of glass substrates having ITO transparent electrode thereon was prepared. A polyimide composition was applied to the inner surfaces of the pair to form polyimide layers respectively and the surfaces of the layers were rubbed respectively to form alignment layers. The space of the cell was filled with a composition CM-1 shown below.

Composition CM-1

| | |
|---|---|
| Nonlinear optical liquid crystal compound (CM-1-1) | 85 parts by weight |
| Photoisomerizable compound (CM-1-2) | 5 parts by weight |
| Hydroquinone monomethyl ether | 4 parts by weight |
| Irgacure 907 | 2 parts by weight |
| Diethyl thioxanthone | 0.7 part by weight |

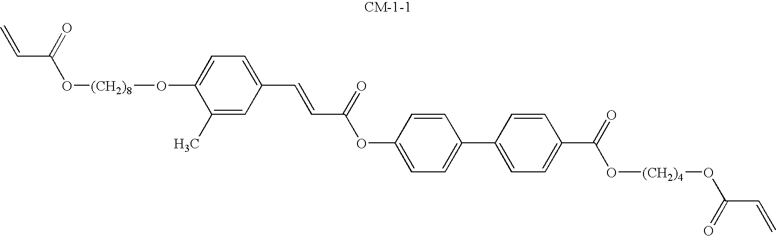

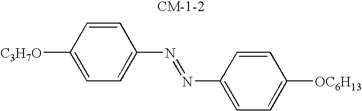

The obtained sample was irradiated with light of 405 nm (30 mW) emitted from gallium nitride (GaN) series semiconductor laser diode under heating at 120° C. while a direct current voltage of 110V was applied to the transparent electrodes, and, then, was cooled to 100° C. Subsequently, UV irradiation (200 mW/cm², 2 minutes) was carried out at 80° C. to give a nonlinear optical material.

When the nonlinear optical material obtained above was irradiated with infrared light (1.06 μm) of YAG laser, it was recognized that the second harmonic was generated from the material. Its intensity was evaluated using quartz as a reference sample. The second harmonic intensity of the sample was held even after 6 months.

### Example No. 2

A horizontal orientation cell (a product of E.H.I. Co.), having a space of 2 μm, comprising a pair of glass substrates having ITO transparent electrode thereon was prepared. A polyimide composition was applied to the inner surfaces of the pair to form polyimide layers respectively and the surfaces of the layers were rubbed respectively -to form alignment layers. The space of the cell was filled with a composition CM-2 shown below.

Composition CM-2

| | |
|---|---|
| Nonlinear optical liquid crystal compound (CM-2-1) | 85 parts by weight |
| Photoisomerizable compound (CM-2-2) | 5 parts by weight |
| Hydroquinone monomethyl ether | 4 parts by weight |
| Irgacure 907 | 2 parts by weight |
| Diethyl thioxanthone | 0.7 part by weight |

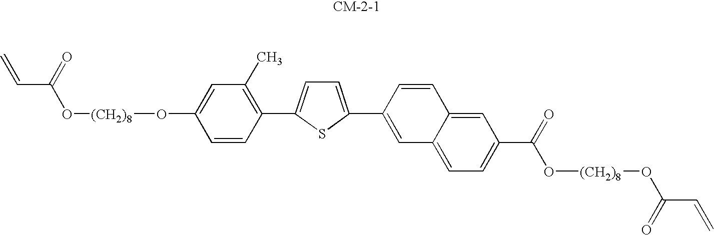

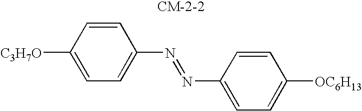

The obtained sample was irradiated with light of 405 nm (30 mW) emitted from gallium nitride (GaN) series semiconductor laser diode under heating at 60° C. while a direct current voltage of 110V was applied to the transparent electrodes, and, then, was cooled to room temperature. Subsequently, UV irradiation (200 mW/cm², 2 minutes) was carried out at room temperature to give a nonlinear optical material. The nonlinear optical material obtained above was evaluated in the same manner as in Example No. 1. Further, regarding the nonlinear optical material obtained above, aluminum was deposited on one side of the glass substrate of the horizontally oriented cell, and the voltage was applied to the electrodes of the cell, and electro-optic modulation effect was observed according to the method described in Appl. Phys. Lett., Vol. 56, p1734 (1990).

### Example No. 3

A horizontal orientation cell (a product of E.H.I. Co.), having a space of 2 μm, comprising a pair of glass substrates having ITO transparent electrode thereon was prepared. A polyimide composition was applied to the inner surfaces of the pair to form polyimide layers respectively and the surfaces of the layers were rubbed respectively to form alignment layers. The space of the cell was filled with a composition CM-3 shown below.

Composition CM-3

| | |
|---|---|
| Nonlinear optical liquid crystal compound (CM-3-1) | 40 parts by weight |
| Liquid crystal compound (CM-3-2) | 40 parts by weight |
| Photoisomerizable compound (CM-3-3) | 10 parts by weight |
| Hydroquinone monomethyl ether | 4 parts by weight |
| Irgacure 907 | 2 parts by weight |
| Diethyl thioxanthone | 0.7 part by weight |

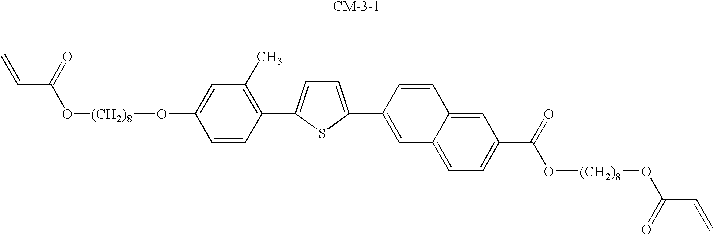

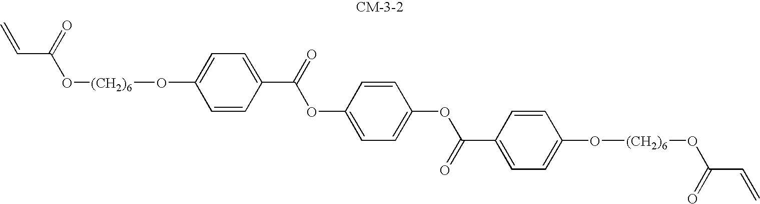

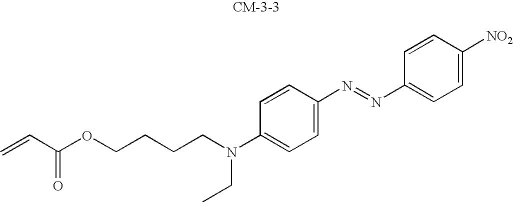

The obtained sample was irradiated with light of 405 nm (30 mW) emitted from gallium nitride (GaN) series semiconductor laser diode under heating at 80° C. while a direct current voltage of 110V was applied to the transparent electrodes, and, then, was cooled to room temperature. Subsequently, UV irradiation (200 mW/cm², 2 minutes) was carried out at room temperature to give a nonlinear optical material. The nonlinear optical material obtained above was evaluated in the same manner as in Example No. 1.

### Example No. 4

A cyclohexane solution of CM-4-1 shown below was applied to a surface of a glass substrate by spin coating (700 rpm, 20 seconds), and, then, was dried under reduced pressure for 12 hours. The sample thus obtained was once heated to 150° C., and then maintained at 100° C. The sample was irradiated with light of 405 nm (30 mW) emitted from gallium nitride (GaN) series semiconductor laser diode while a voltage of −10 kV was applied according to a corona poling method. Subsequently, the sample was cooled to room temperature while being applied with a voltage, thereby preparing a nonlinear optical material. The nonlinear optical material obtained above was evaluated in the same manner as in Example No. 1.
CM-4-1

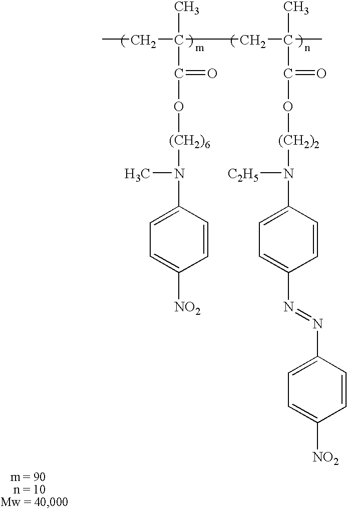

### Example No. 5

A cyclohexane solution of the following composition CM-5 was applied to a surface of a glass substrate by spin coating (700 rpm, 20 seconds), and then was dried under reduced pressure for 12 hours. The sample thus obtained was once heated to 150° C., and then maintained at 100° C. The sample was irradiated with light of 405 nm (30 mW) emitted from gallium nitride (GaN) series semiconductor laser diode while a voltage of −10 kV was applied according to a corona poling method. Subsequently, the sample was cooled to room temperature while being applied with a voltage, thereby preparing a nonlinear optical material. The nonlinear optical material obtained above was evaluated in the same manner as in Example No. 1.

Composition CM-5

| | |
|---|---|
| Polymer (CM-5-1) | 80 parts by weight |
| Photoisomerizable compound | 20 parts by weight |
| (CM-5-2) | |

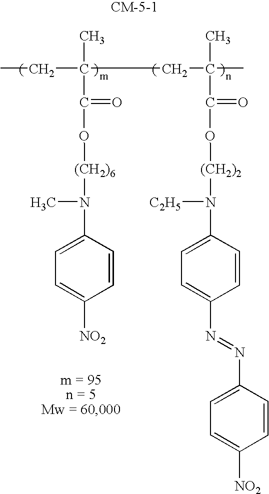

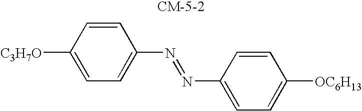

### Comparative Example No. 1

A horizontal orientation cell (a product of E.H.I. Co.), having a space of 2 μm, comprising a pair of glass substrates having ITO transparent electrode thereon was prepared. A polyimide composition was applied to the inner surfaces of the pair to form polyimide layers respectively and the surfaces of the layers were rubbed respectively to form alignment layers. The space of the cell was filled with a composition RCM-1 shown below.

Composition RCM-1

| | |
|---|---|
| Nonlinear optical liquid crystal | 85 parts by weight |
| compound (CM-1-1) | |
| Hydroquinone monomethyl ether | 4 parts by weight |
| Irgacure 907 | 2 parts by weight |
| Diethyl thioxanthone | 0.7 part by weight |

The obtained sample was heated to 120° C. while a direct current voltage of 110V was applied to the transparent electrodes, and, then, was cooled to 100° C. Subsequently, UV irradiation (200 mW/cm², 2 minutes) was carried out at 80° C. to give a sample for comparison with Example No. 1.

The nonlinear optical material obtained above was evaluated in the same manner as in Example No. 1. As a result, its second harmonic intensity was lower than that of the sample prepared in Example No. 1.

### Comparative Example No. 2

A horizontal orientation cell (a product of E.H.I. Co.), having a space of 2 μm, comprising a pair of glass substrates having ITO transparent electrode thereon was prepared. A polyimide composition was applied to the inner surfaces of the pair to form polyimide layers respectively and the surfaces of the layers were rubbed respectively to form alignment layers. The space of the cell was filled with a composition RCM-2 shown below.

Composition RCM-2

| | |
|---|---|
| Nonlinear optical liquid crystal | 85 parts by weight |
| compound (CM-2-1) | |
| Hydroquinone monomethyl ether | 4 parts by weight |
| Irgacure 907 | 2 parts by weight |
| Diethyl thioxanthone | 0.7 part by weight |

The obtained sample was irradiated with light of 405 nm (30 mW) emitted from gallium nitride (GaN) series semiconductor laser diode under heating at 60° C. while a direct current voltage of 110V was applied to the transparent electrodes, and, then, was cooled to room temperature. Subsequently, UV irradiation (200 mW/cm², 2 minutes) was carried out at room temperature to give a sample for comparison with Example No. 2.

The nonlinear optical material obtained above was evaluated in the same manner as in Example No. 1. As a result, its second harmonic intensity was lower than that of the sample prepared in Example No. 2.

### Comparative Example No. 3

A horizontal orientation cell (a product of E.H.I. Co.), having a space of 2 μm, comprising a pair of glass substrates having ITO transparent electrode thereon was prepared. A polyimide composition was applied to the inner surfaces of the pair to form polyimide layers respectively and the surfaces of the layers were rubbed respectively to form alignment layers. The space of the cell was filled with a composition RCM-3 shown below.

Composition RCM-3

| | |
|---|---|
| Nonlinear optical liquid crystal | 40 parts by weight |
| compound (CM-3-1) | |
| Liquid crystal compound (CM-3-2) | 40 parts by weight |
| Hydroquinone monomethyl ether | 4 parts by weight |
| Irgacure 907 | 2 parts by weight |
| Diethyl thioxanthone | 0.7 part by weight |

The obtained sample was irradiated with light of 405 nm (30 mW) emitted from gallium nitride (GaN) series semiconductor laser diode under heating at 80° C. while a direct current voltage of 110V was applied to the transparent electrodes, and, then, was cooled to room temperature. Subsequently, UV irradiation (200 mW/cm², 2 minutes) was carried out at room temperature to give a nonlinear optical material.

The nonlinear optical material obtained above was evaluated in the same manner as in Example No. 1. As a result, its second harmonic intensity was lower than that of the sample prepared in Example No. 3.

### Comparative Example No. 4

A nonlinear optical material was prepared in the same manner as in Example No. 4, except for using RCM-4-1 shown below in place of CM-4-1.
RCM-4-1

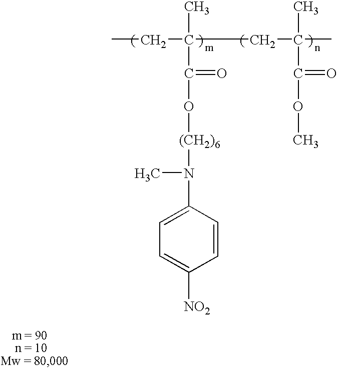

The nonlinear optical material obtained above was evaluated in the same manner as in Example No. 1. As a result, its second harmonic intensity was lower than that of the sample prepared in Example 4.

The evaluate results of Example Nos. 1 to 5 and Comparative Example Nos. 1 to 4 are shown in Table 1

TABLE 1

| | Second Harmonic Intensity |
|---|---|
| Sample | for Quartz |
| Example No. 1 | 2.3 |
| Example No. 2 | 3.1 |
| Example No. 3 | 1.5 |
| Example No. 4 | 4.2 |
| Example No. 5 | 4.8 |
| Comparative Example No. 1 | 0.4 |
| Comparative Example No. 2 | 0.4 |
| Comparative Example No. 3 | 0.6 |
| Comparative Example No. 4 | 1.1 |

### INDUSTRIAL APPLICABILITY

According to the present invention, it is possible to provide a nonlinear optical organic material having a large nonlinear optical responsiveness, and also having no orientational relaxation or suppressed orientation relaxation. And it is also possible to provide a composition, an optical element and production methods useful for the production of the nonlinear optical material.

1. A composition for a nonlinear optical material comprising:
at least one liquid crystalline/nonlinear optically-responsive compound having at least one polymerizable group and at least one nonlinear optically-responsive group, and
at least one compound having at least one photoresponsive isomerization group.

2. The composition of claim 1, further comprising at least one liquid-crystalline compound having at least one polymerizable group.

3. The composition of claim 1, wherein the liquid crystalline/nonlinear optically-responsive compound has a plurality of polymerizable groups.

4. The composition of claim 1, wherein liquid-crystalline compound has a plurality of polymerizable groups.

5. The composition of claim 1, wherein the compound having at least one photoresponsive isomerization group is selected from azo compounds.

6. An optical element comprising a layer formed of a composition as set forth in claim 1.

7. A nonlinear optical material comprising a nonlinear optically-responsive layer formed by exposing a layer formed of a composition to light under an external electric field or an external magnetic field,
wherein the composition comprises at least one liquid crystalline/nonlinear optically-responsive compound having at least one polymerizable group and at least one nonlinear optically-responsive group, and at least one compound having at least one photoresponsive isomerization group.

8. The nonlinear optical material of claim 7, used as an electro-optical (EO) light modulation material.

9. The nonlinear optical material of claim 7, wherein the light has a peak wavelength of from 200 to 700 nm.

10. The nonlinear optical material of claim 7, wherein the composition further comprises at least one liquid-crystalline compound having at least one polymerizable group.

11. The nonlinear optical material of claim 7, wherein the nonlinear optically-responsive layer comprises a polymer of the liquid crystalline/nonlinear optically-responsive compound.

12. The nonlinear optical material of claim 10, wherein the nonlinear optically-responsive layer comprises a polymer of the liquid-crystalline compound having at least one polymerizable group.

13. An optical element comprising a layer comprising at least one polymer having at least one nonlinear optically-responsive group and at least one photoresponsive isomerization group.

14. The optical element of claim 13, wherein the layer further comprises at least one compound having at least one photoresponsive isomerization group.

15. An optical element comprising a layer comprising at least one polymer having at least one nonlinear optically-responsive group and at least one compound having at least one photoresponsive isomerization group.

16. A non-linear optical material comprising a nonlinear optically-responsive layer formed by exposing a layer formed of a composition to light under an external electric field or an external magnetic field,
wherein the composition comprises at least one polymer having at least one nonlinear optically-responsive group and at least one photoresponsive isomerization group, or comprises at least one polymer having at least one nonlinear optically-responsive group and at least one compound having at least one photoresponsive isomerization group.

17. The nonlinear optical material of claim 16, used as an electro-optical (EO) light modulation material.

18. A process for producing a nonlinear optical material comprising exposing a composition to light under an external electric field or an external magnetic field, thereby forming a nonlinear optically-responsive moiety,
wherein the composition comprises at least one liquid crystalline/nonlinear optically-responsive compound having at least one polymerizable group and at least one nonlinear optically-responsive group, and at least one compound having at least one photoresponsive isomerization group.

19. A process for producing a nonlinear optical material comprising exposing a polymer, having at least one nonlinear optically-responsive group and/or at least one photoresponsive isomerization group, to light under an external electric field or an external magnetic field, thereby forming a nonlinear optically-responsive moiety.
